(19) United States
(12) Patent Application Publication
(10) Pub. No.: US 2006/0123484 A1
(43) Pub. Date: Jun. 8, 2006

(54) Method of clearing and delivering digital rights management licenses to devices connected by IP networks

(76) Inventors: Miodrag Babic, Las Vegas, NV (US); Michael W. Rosa, Las Vegas, NV (US); Brian K. Walker, Las Vegas, NV (US); Hridaynath E. Musale, Sunnyvale, CA (US)

Correspondence Address: WEIDE & MILLER, LTD., 7251 W. LAKE MEAD BLVD., SUITE 530, LAS VEGAS, NV, 89128, US

(21) Appl. No.: 11/286,443

(22) Filed: Nov. 23, 2005

Related U.S. Application Data
(63) Continuation-in-part of application No. 10/794,328, filed on Mar. 4, 2004.

(51) Int. Cl. H04N 7/16; G06Q 99/00; H04L 9/32; G06F 17/30; H04L 9/00; G06F 7/04; H04K 1/00; G06K 9/00; H03M 1/68

(52) U.S. Cl. 726/26; 705/59

(57) ABSTRACT

A method for clearing and delivering digital rights management (DRM) licenses to websites and IP connected devices is disclosed. The method utilizes one or more Web services to receive one or more license requests from devices connected by IP Networks and generates, clears and delivers licenses containing license keys and rights or rules that govern the use of one or more digital media file or live broadcast. Use of a Web service unifies numerous complex steps and insures proper interface between otherwise potentially incompatible software and hardware modules which may be distributed at various remote locations. License clearing and delivery may then be performed seamlessly and transparently to a virtually unlimited number of devices connected by IP Networks.

### RELATED APPLICATION

This application is a continuation-in-part of U.S. patent application Ser. No. 10/794,328 filed on Mar. 4, 2004, which is incorporated by reference herein.

### FIELD OF THE INVENTION

The invention relates to computer software and associated systems and more particularly to a method of clearing and delivering digital rights management licenses to devices connected by Internet Protocol (IP) Networks using a Web service.

### RELATED ART

The Internet and personal computers have dramatically changed the way digital media content, such as music, films, and books, are produced, distributed and consumed. Streaming and downloading encoded files has gained acceptance among computer users because it provides immediate access to desired content and does not require a trip to a store or reliance on physical media, such as a compact disc (CD) or a digital video disc (DVD).

However, digital media content that is available for sale on the Internet is still limited, as content owners, artists, and publishers are concerned about protecting their copyrighted works from illegal use. As the market evolves and content owners explore new ways of enabling different business models, more premium content will become available on the Internet and other devices such as portable media players, set-top-boxes and mobile phones may be connected by IP networks.

Before owners of premium digital media content will offer their valuable content for sale or promotion, a secure and scalable media system that protects digital content from illegal use is needed. A component of any such system is digital rights management (DRM). Absent such a system, digital content may be copied and resold without payment to or control by the copyright owner.

DRM is a technology that content owners can use to protect their copyrights and stay in closer contact with their customers. In most instances, DRM is a system that encrypts digital media content and limits access to those consumers who have acquired an authorized license to play the content.

DRM secures content by creating a version of a media file or a broadcast that has been encrypted and locked with a “key.” A consumer must first acquire a license key to unlock and play an encrypted digital media file. Each license contains the key to unlock the digital media file or a live broadcast and rights or rules that govern the use of the digital media file or the live broadcast. By way of example, rights may allow a consumer to play digital media file on a specific computer and to copy the file to a portable device. If a consumer sends a packaged digital media file to a friend, this friend must acquire his or her own license to play the file since licenses are not transferable. Thus, DRM is a technology that assists in secure distribution, promotion, and sale of digital media content over IP networks.

IP networks may include an Internet, Intranets, Television, Mobile Phone and other types of networks that connect multiple and different electronic devices including set-top-boxes, mobile phones, digital video recorders, and other IP devices. DRM license clearing and delivery is the process of issuing licenses to those devices connected by the IP networks.

Currently content owners may choose to develop and host DRM platforms for license clearing and delivery on their own servers. Alternatively, content owners may purchase DRM license clearing and delivery services from third parties that host license clearing and delivery services on one or more of their servers.

However, prior art systems and options for DRM licensing have numerous drawbacks. One such drawback is a dependency on the same server uptime and functionality for both web serving and license clearing and delivery services.

Another drawback is that a license clearing and delivery process requires very intensive central process unit (CPU) usage and is limited to the number of licenses that a single server can issue effectively.

Another drawback is that a consumer might have to leave a content owner's Web site or media platform to receive a license at third party's Web site and DRM platform if the content owner chooses to use third party DRM license clearing and delivery service.

Another drawback is a dependency on multiple disparate databases in situations where a content owner chooses to use third party license clearing and delivery services. Typically, media or broadcast information is held on a content owner's Web site and database. However, license key information and Web pages that may issue licenses are held on a third party's Web site and database. Consequently, protected content may not be provided to an ever increasing number of consumers requesting licenses unless an improved process or system is provided. Such an improved process or system should provide cleared and delivered licenses transparently on a single platform regardless of whether a third party DRM license clearing and delivery service provider is used or not. Furthermore, such an improved process or system should be accessible without having to leave a content owner's Web site or media platform. The method and apparatus described below overcomes the drawbacks of the prior art.

### SUMMARY

In one embodiment of the disclosure, a method is disclosed for license clearing and delivery to devices connected by IP networks using Web service.

A device residing on the IP network (such as a PC, a set-top box or a mobile device), generates an internal request to acquire a license for a given piece of media or live broadcast.

An Extensible Markup Language (XML)-compliant, Simple Object Access Protocol (SOAP) envelope of information is prepared.

A Remote Procedure Call (RPC) is placed to the licensing Web service by sending the SOAP envelope via Secured Sockets Layer (SSL)-secured protocol such as HyperText Transport Protocol Secure (HTTPS). The RPC is placed into a “wait state” for a response from the licensing server.

The Web service receives the request and first authenticates the user against a database to verify the authenticity of the call.

Once authenticated, the database sends the license key information that also includes the rights or rules that govern the use of the digital media file or live broadcast, to the Web service internal response mechanism.

The Web service response mechanism wraps the response information containing the license key and sends it back to the RPC, still in a “wait state.”

On receipt, the web server or device script parses the response, ending the “wait state,” and matches it to the encrypted media file or live broadcast header. Based on the parsed response, the process can elect to either deliver the license key or take some other action.

In a second embodiment of the disclosure, a method of clearing and issuing licenses by at least one DRM Web service to an IP device to play copyrighted media and broadcast is disclosed. In one step, device unique information is collected from at least one IP device. In another step, an XML RPC is received from at least one IP device comprising an XML-compliant SOAP envelope having device unique information and at least one license identifier to request at least one license for at least one of the following: a portion of digital media and live broadcast. In further steps of the method an XML RPC is placed in a wait state and authentication information and at least one license identifier is compared with at least one database located at the DRM Web service by running a Web service authentication. Furthermore, in yet other steps of the method the license identifier and authentication information are verified by matching a DRM information and encrypted username and password held in the at least one database and license key information including at least one of rights and rules governing the use of at least one of the following: digital media file and live broadcast are sent to a DRM Web service response mechanism. Response information comprising at least one license key information by the DRM Web service response mechanism are wrapped, the response information is sent to the XML RPC the response information is parsed to end the XML RPC wait state. The response information is matched to at least one of the following: encrypted media file and live broadcast; and decrypting at least one of the following: encrypted media and live broadcast is decrypted to permit playing of at least one of the following: decrypted media and live broadcast on at least one IP device.

In a third embodiment of the disclosure a system for providing a DRM license to play copyrighted media and live broadcast is disclosed. The system comprises, in combination, at least one IP device having an embedded script designating device unique information, the IP device in secured communication with at least one DRM Web service hosted by at least one DRM Web service server configured to receive an XML-compliant SOAP envelope having DRM information and to transmit at least one license to decrypt at least one of a portion of media and live broadcast for playing on at least one IP device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

Components in the accompanying figures are not necessarily to scale, emphasis instead being placed upon illustrating the principles of the invention. In the figures, like reference numerals designate corresponding parts throughout the different views.

FIG. 1 illustrates a block diagram of an example environment of use and exemplary system utilized or accessed during use of the method and apparatus disclosed herein.

FIG. 2 illustrates a block diagram of an example embodiment of a license delivery and content distribution system.

FIG. 3 illustrates a block diagram of an example embodiment of the ISP Software Package to media management interface and media management database.

FIG. 4 illustrates a block diagram of an example embodiment of a DRM Media Management System.

FIG. 5 illustrates a block diagram of an example embodiment of the ISP secured media distribution system.

FIG. 6 illustrates an operational flow diagram of an example method of a first click initialization process.

FIG. 7 illustrates an operational flow diagram of an example method of a second click start encoding process.

FIG. 8 illustrates an operational flow diagram of an example method of a third click stop encoding operation.

FIG. 9 illustrates an operational flow diagram of an example method of package creation.

FIG. 10 illustrates a block diagram of an example environment of use and exemplary system utilized or accessed during use according to an embodiment of a method for clearing and delivering licenses to devices on IP Networks.

FIG. 11 illustrates a block diagram of an exemplary embodiment of use of a Web service to clear and deliver licenses to devices on IP Networks.

FIG. 12 illustrates a block diagram of an example embodiment of a scalable Web service based license clearing and delivery system.

FIG. 13 illustrates a schematic of a Simple Object Access Protocol (SOAP) envelope structure for use in an exemplary embodiment of a method for clearing and delivering licenses to device on IP networks according to this disclosure.

### DETAILED DESCRIPTION

In the following detailed description of exemplary embodiments of the invention, reference is made to the accompanying drawings, which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical and other changes may be made without departing from the spirit or scope of the present invention. It will be apparent, however, to one skilled in the art, that the present invention may be practiced without these specific details. In other instances, well-known features have not been described in detail so as not to obscure the invention.

To overcome the drawbacks of the prior art, the method described herein describes seamless and transparent methodology to clear and deliver licenses to numerous devices connected by the IP networks. The method described herein is available from iStreamPlanet, Co. located in Las Vegas, Nev. and as such term “ISP” as used herein refers to one or more components, software, processes, system or methods invented or assembled by iStreamPlanet, Co.

In general, the process of protecting media and live broadcasts with digital rights management (DRM) consists of: (1) encryption; (2) setting rights or rules that govern the use of the digital media file or live broadcast; and (3) license clearing and delivery. Encryption may be performed using software and applications designed to encrypt the media or live broadcast with designated DRM encryption information. Content owners set rights or rules that govern the use of the digital media file or live broadcast. There are many different rules including number of times media can be played, number of times media can be burnt to a CD, number of times media can be transferred to a portable device, license start date, license expiration date, and others.

In general, an end-to-end secured media distribution system over the Internet consists of: (1) media acquisition and digitalization; (2) media encryption; (3) secured media delivery based on business rules that govern content distribution via live streaming, on-demand streaming or downloading; and (4) license delivery and managed media access and playback. Media encryption may be performed using a digital rights management (DRM) encryption scheme that encrypts the media and requires a license to unlock the media so media can be played with the media player.

Streaming media technology enables the real time or on demand distribution of audio, video and multimedia on the Internet. Streaming media may be considered as the simultaneous transfer of digital media (video, voice and data) so that it is received as a continuous real-time stream. Streamed data may be transmitted by a server application and received and displayed in real-time by client applications. These applications can start displaying video or playing back audio as soon as enough data has been received and stored in the receiving station's buffer. A streamed file is simultaneously downloaded and viewed, but leaves behind no physical file on the viewer's machine. Downloading leaves a file on the viewer's machine which can but does not need to be viewed at the time of the download. The term machine as used herein is defined to mean any device, computer, or system capable of or configured to receive streamed data for presentation to a viewer, listener or both.

Initially, it will be appreciated that there are numerous definitions of Extended Markup Language (denoted XML hereinafter) Web service. However, in general most XML Web services have the following in common: (1) XML Web services provide useful functionality to Web users through an interface using standardized Web protocol termed Simple Object Access Protocol (denoted SOAP hereinafter); (2) XML Web services provide a way to describe their interfaces in enough detail to allow a user to build a client application to communicate with them. This description is usually provided in an XML document called a Web services Description Language (denoted WSDL hereinafter) document; (3) XML Web services are registered so that potential users can find them easily. This is done with Universal Discovery Description and Integration (denoted UDDI hereinafter).

One of the primary advantages of the XML Web service architecture is that it allows programs written in different languages on different platforms to communicate with each other in a standardized way. Another significant advantage that XML Web services have over previous communication methods is that they work with standard Web protocols including but not limited to SOAP, Hyper Text Transfer Protocol (denoted HTTP hereinafter), secured HTTP (denoted HTTPS hereinafter) and Transmission Control Protocol/Internet Protocol (denoted TCP/IP hereinafter).

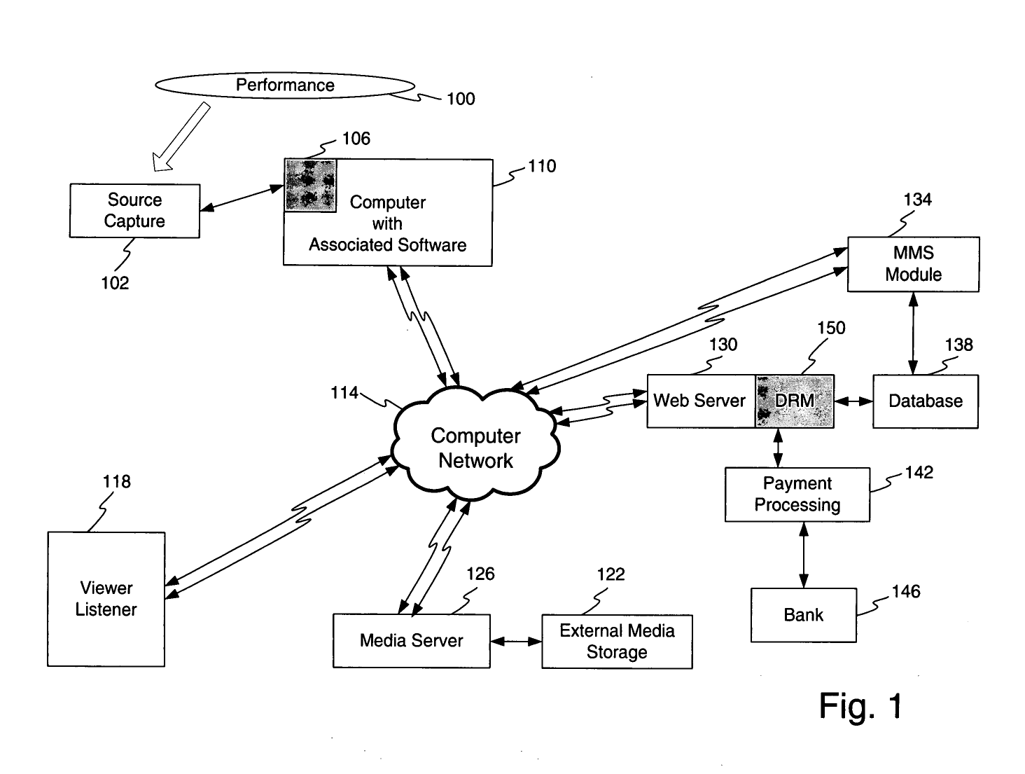

FIG. 1 illustrates a block diagram of an example environment of use and exemplary system utilized or accessed during use of the method and apparatus disclosed herein. It is contemplated the ISP system and method as described herein may operate in other exemplary environments. As shown in this example embodiment, the performance 100 may comprise any type event such as any concert or competition or performance, or may comprise a prerecorded event, such as a previously digitized performance. A source capture device 102 such as the camera, microphone, or electrical connection captures the performance. It is contemplated that there may be more than one capture device 102. The capture device 102 provides the electrical or optical signal representing the performance 100 to an interface card 106 configured to be compatible with a computer with associated software 110. The interface card 106 may comprise a video or audio processing device and may include one or more analog to digital converters as is understood by one of ordinary skill in the art. The computer 110 may comprise any type computer capable of performing the functions and executing software as described herein. It is contemplated that in one embodiment the ISP Software Package that is configured to provide the method and apparatus described herein may operate and reside on the computer 110. The functionality of the ISP Software Package is described below in more detail.

The computer 110 interfaces or otherwise connects to a computer network 114 configured to transfer digital data between one or more remote locations. In one embodiment the computer network 114 comprises the Internet as is understood by one of ordinary skill in the art. Also connected to the computer network 114 is a viewer or listener 118, which also may be referred to herein as an end-user. It is contemplated that the end-user 118 is desirous of viewing or listening to or otherwise obtaining access to the performance 100. However, to facilitate such transfer of digital content it may be desired by the copyright owner of the performance to obtain payment from the end-user 118 and ensure protection of the digital content provided to the end-user.

To facilitate this transaction of digital content, an operator utilizing the computer 110 establishes a connection with media server 126 and secure connection with MMS Module 134 to thereby oversee control and access to the content. In one embodiment the content is stored on external media storage 122 which may be accessed via media server 126. As is understood an end-user 118 may utilize the computer network 114 such as with a web browser to gain access to the content via the media server 126 and external media storage 122. The content may be streamed from the media storage 122 by using the media server or directly downloaded.

As part of this process an operator at the computer 110 may establish an event or package which may be accessed at a remote web server 130. As described below in more detail the operator provides information regarding the event or package via MMS Module 134 to the database 138, which the end-user 118 may access to selectively purchase or obtain access to the content via remote web server 130.

Associated with the server 130 is Media Management System (MMS Module) 134 which may be used to create and modify events and assign media to the events, create and modify business scenarios for media delivery and package events as a standalone single event or combination of events for the playback by end-users and to facilitate exchange of DRM encryption information. The web server 130 also communicates with a database 138. The database 138 is configured to store all information about the content that can be updated in real-time by the operator on computer 110 or by using MMS Module 134. The term content is defined to mean the digital information, such as video, audio, or both, provided to an end-user. In this embodiment the database is used to store event information, package information, customer information and all DRM information that is used to encrypt the content and generate licenses. It is contemplated that the media may be stored on the media storage, such as a server, NAS (network attached storage) or SAN (storage area network). Also associated with the web server 130 is a payment processing unit 142 which may be in communication with a bank or financial institution 146. Processing of payments via online credit card or debit card or check transactions is generally understood in the art and as such is not described in detail herein. It is contemplated, however, that the end-user 118 may request access via web server to an event established by an operator at computer 110 and as part of the obtaining or granting access, the end-user may provide payment which is verified utilizing payment processing unit 142 and bank 146 and/or financial institution. Further, associated with the web server 130 is digital rights manager 150. In one embodiment the digital rights manager 150 can be installed on a web server 130 and called directly to issue licenses. It is also contemplated that the digital rights manager may be called or accessed from or on a different server.

Upon proof of payment for access to content established by a user at the computer 110 the web server or other software component generates a request-to a digital rights manager 150 to generate and grant a digital rights management license to the end-user 118. In one embodiment this occurs by passing the license information for that particular piece of content from the database 138 to the digital rights manager 150. The transfer of a license to an end-user 118 may occur when end-user 118 clicks on the content link to access the content. It is contemplated that the license may comprise a code or other password which may or may not be known to the end-user.

After granting of a license by the digital rights manager 150 the end-user 118 is able to access the content stored on the external media storage 122 via media server 126 or live content delivered directly via media server 126. It is contemplated that the data on the external media storage 122 may be published worldwide via one or more media servers 126, only one of which is shown in FIG. 1. It is further contemplated that the computer 110 may interface with the digital rights manager 150 upon establishment of the event at the MMS Module 134 to thereby establish encryption of the digital content which may be unlocked or decoded, i.e. unencrypted upon use of the license granted by the digital rights manager 150 and web server 130. It should be noted that this is but one possible implementation of an example environment of use for the method and apparatus described herein and as such the claims that follow should not be considered as being limited to the environment shown in FIG. 1.

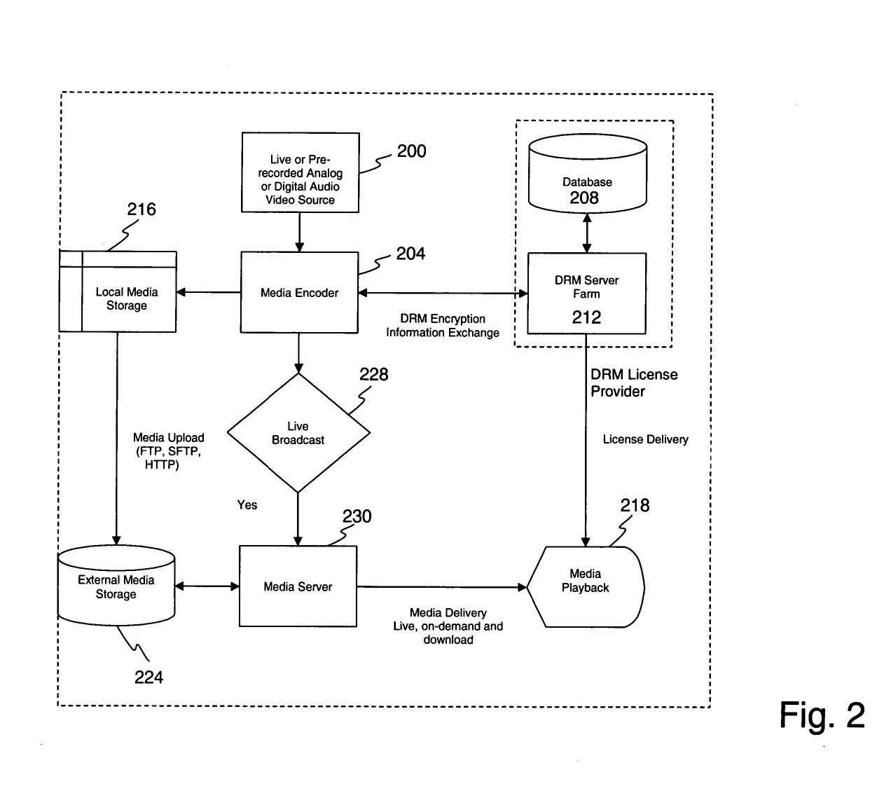

FIG. 2 illustrates a block diagram of an example embodiment of a license and content distribution system. As shown in FIG. 2 a content source 200 which may comprise live or prerecorded analog or digital information, provides a signal representing the performance or audio or video source, to a media encoder 204 configured to process the signal in accordance with the method and apparatus described herein. In one embodiment this comprises encryption of the signal. As part of the encryption it is contemplated that communication and exchange of information may occur which may involve a DRM encryption information exchange operation between one or more servers, such as, for example, a server farm 212 which is in communication with a database 208. The encryption information exchange operation provided to the media encoder 204 may be incorporated with the encryption process of the content from the source 200. It is contemplated that the DRM license provider may also deliver a license to an end-user via DRM server to facilitate media playback 218.

The media encoder may optionally provide the encrypted content for storage at a storage location 216 which may turn forward to content to external media storage 224. Alternatively the media encoder 204 may output the content for live streaming broadcast 228. This content may be routed to the media playback device 218 via media server 230 and thus, in this manner the delivery may occur on a live, on-demand, or download basis.

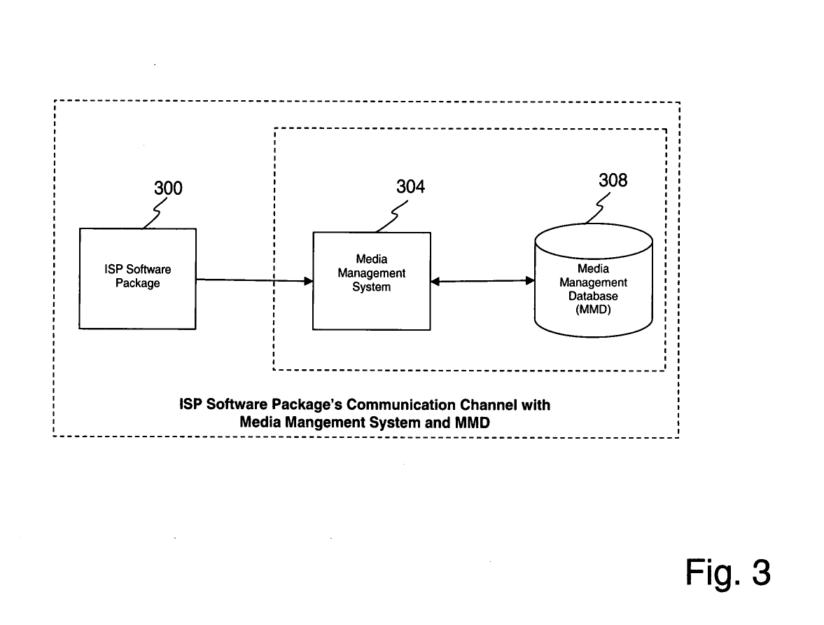

FIG. 3 illustrates a block diagram of an example embodiment of the ISP Software Package communication with the media management interface. This is but one possible interface and as such one of ordinary skill in the art may arrive at other interface configurations and methods of operation which do not depart from the claims that follow. It is contemplated that the ISP Software Package 300 has a web-based access to Media Management System 304 and has ability to update Media Management Database (MMD) 308 via Media Management System 304. It is contemplated that the Media Management System 304 may access or communicate with the MMD 308. In operation, these elements, 300, 304, and 308 give an operator of the ISP Software Package ability to manage secured media distribution process in real-time.

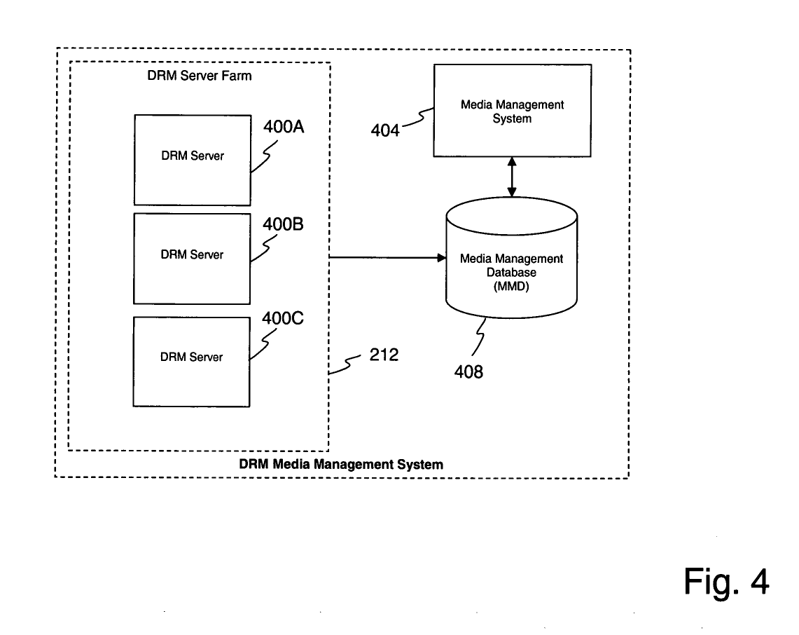

FIG. 4 illustrates a block diagram of an example embodiment of the DRM Media Management System. One of ordinary skill in the art may arrive at other embodiments without departing from the scope of the invention. The DRM system shown in FIG. 4 may be similar to elements 208 and 212 in FIG. 2. In this example embodiment, a DRM server farm 212 comprises one or more servers 400A, 400B, 400C which are load balanced to be able to handle potentially infinite number of end-users requesting licenses. The servers may access a Media Management Database (MMD) 408 which stores some or all DRM information necessary to issue license dynamically. The database 408 may be populated and controlled by a Media Management System 404. In general, the DRM Media Management System integrates Media Management System 404, Media Management Database 408 and DRM Server Farm with ISP Software Package to create manageable secured media distribution system.

As an advantage over the prior art, the method and apparatus described and claimed herein may be presented in unified software package configured to seamlessly unify the numerous complex and required steps under control of a single software package and implement the process in the proper order and only after completion of the proper steps as embodied herein. Absent the method and apparatus described herein it would not be possible to synchronize operation of the various activities to achieve content encryption, and license delivery in a manner that would allow access by an end-user.

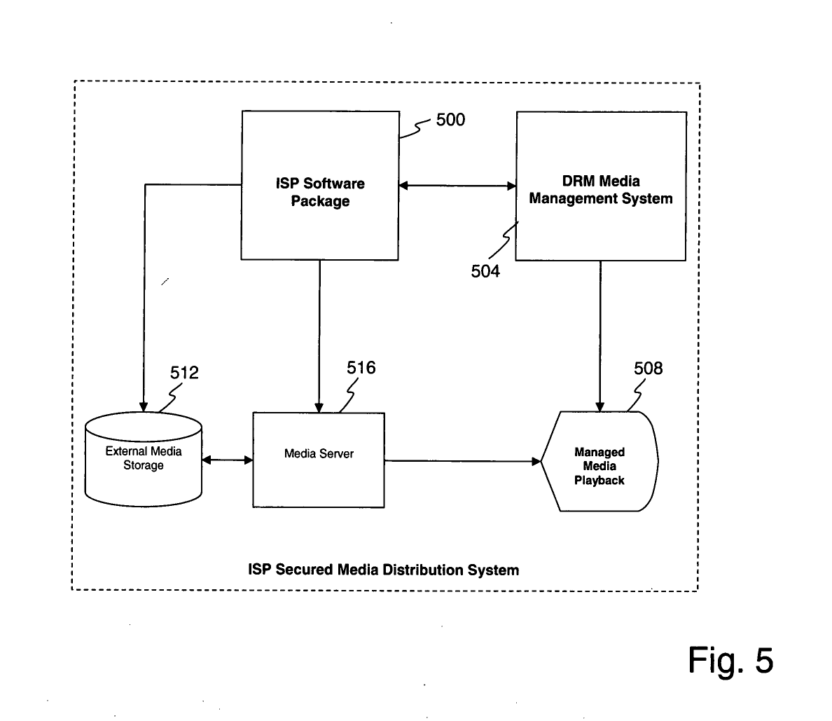

FIG. 5 illustrates a block diagram of an example embodiment of the ISP secured media distribution system. This is but one possible example embodiment of a secured media distribution system. In general, in this example embodiment, the ISP Software Package and DRM Media Management System are configured to perform all four steps of secured media delivery process (1) media acquisition and digitalization; (2) media encryption; (3) secured media delivery based on business rules that govern content distribution via live streaming, on-demand streaming or downloading; and (4) license delivery and managed media access and playback.

In this embodiment an ISP Software Package 500 processes data to generate encrypted, license accessible content having one or more rules associated therewith, that govern use or other aspects, associated therewith. As part of the processing, referred to herein as encoding, the encoder 500 interfaces or communicates with the DRM Media Management System 504. In one embodiment the management system 504 generates and provides the DRM encryption schema information to the encoder 500. In another embodiment the DRM encryption schema information may be generated at or by a device or system other than the management system 504. In one embodiment the DRM encryption schema comprises of private key, public certificate, license certificate, root certificate, public key and seed. The encoder 500 may be configured to output the content to external media storage for use in other than streaming media environment, or provide streaming media directly to a media server 516. The media server 516 comprises a connection location to which an end-user may connect to obtain the content. In one embodiment a managed media playback device 508 connects to the media server to obtain either the content as streaming data, such as for real time viewing, or from the media 512, as a download or on-demand. It is contemplated that the streaming data may also be stored by the end-user for future use.

In one embodiment the encoding process consists of multiple steps including: (1) setting capture device, (2) video and audio source selection, (3) selecting broadcast or encoding type that can be live broadcast, capture to a file, file conversion or screen capture, (4) providing live broadcast settings including server media acquisition method that can be: (a) pulled where streaming media server or group of servers initiate connection with the encoder via encoder's IP address and port used to broadcast media, or (b) pushed where encoder pushes content to the streaming media server via IP address and publishing point, (5) selecting encoding profile that consist of bit rate, frame rate and buffer size settings, (6) selecting if encoded audio and video will be archived and if so, at what location should archived file be stored, (7) information about the media that can but doesn't have to be displayed during the playback of the media and includes title, author, copyright, rating and description information. Of course, these are the steps that occur as part of the media acquisition and digitalization. As can be appreciated, these are a summary of the steps and as such, each step comprises numerous sub-steps and other steps may be listed.

As an advantage of the method and apparatus claimed herein, the numerous processes are not only configured to provide for distribution of secure content based on license rights. The oversight and control of these numerous complex and confusing processes may be unified and synchronized with a unified software package configured to run from a single location yet access and control network elements at a variety of remote locations.

It is further contemplated that there are at least four different ways a license can be delivered to the end-user: (1) non-silent where end-user is prompted to do something; (2) silent where there is no end-user interaction required; (3) non-pre-delivered where license is acquired separately and after media has been acquired; (4) pre-delivered where license is acquired before or at the time media is acquired. By way of example, when using Windows Media Encoder, media encryption requires integration with DRM server which is the server responsible for generating encryption scheme elements and generating and delivering the license that will unlock encrypted media. A purpose of integration between Windows Media Encoder and DRM server is to exchange encryption scheme information and to create a DRM Profile that contains all encryption scheme information and it is used by the Encoder to encrypt the media.

In one embodiment to establish the connection with DRM license provider's DRM server and to generate all encryption scheme information, an encoder operator needs to go through the following steps: (1) inside Windows Media Encoder Properties option operator needs to access Security tab; (2) DRM license sever provider who hosts DRM servers needs to be added to the list along with the URL that connects encoder to provider's DRM server; (3) this is where DRM profile creation takes place and it consists of: (a) DRM server passes private key, public certificate, license certificate, root certificate and a seed to the Encoder; (b) upon reception, Encoder passes back to DRM server a public key, seed and DRM profile created; (4) encoder operator needs to select created DRM profile and apply the selected profile so Encoder uses selected profile for media encryption; (5) once DRM profile is applied, encoder returns the Key ID; (5) to complete the process, Encoder operator needs to pass back the Key ID to the DRM license server provider so license server provider can pre-deliver license that will unlock the encrypted media created with the Encoder. Once Encoder operator starts the process of encoding, video and audio will be converted to compressed encrypted media. This concludes step 2.

Currently steps 3 and 4 are not integrated with Windows Media Encoder or any other encoding software and there are no solutions on the market that give an encoder operator the ability to control media access so users access media once media is ready for distribution and all encryption scheme information is available to DRM license sever provider and license that unlocks the media can be created and issued to authorized end-users. In the prior art an encoder operator may perform media acquisition, digitalization and encryption as described above without having direct communication with DRM license provider and front-end system such as website that pre-delivers the license to the end-user and grants the access to the media. As a result the end-user is often unable to play the media because: (1) end-user gets the invalid license to the media which was created with an incorrect Key ID because an encoder operator has not passed the updated Key ID back to DRM license provider; (2) end-user gets access to media URL before media has been created; (3) if media is to be accessed via on-demand streaming or downloading, media file needs to be placed on a server, media storage or any other file handling mechanism that serves media files. Typically media is transferred to such device via file transfer protocol (FTP) or secure file transfer protocol (SFTP) however there are other methods such as HTTP upload or copying files directly from encoder file system to file handling mechanism. If media is not placed or a URL path to the media is not created and passed on to the end-user, end-user will not be able to play the media.

Thus, as can be appreciated, the importance of passing back Key ID and pre-delivery license model should not be discounted. When using pre-delivery as a license delivery method, operator or media encryption system is able to encrypt media only once and retains ability to create different licenses with different business rules and issue them to multiple end-users. When using other license delivery methods such as silent delivery, operator or media encryption system can encrypt media for each end-user and needs to embed content ID and/or some other piece of information that can be used to authenticate end-user so media can only be played by authorized end-user.

As an advantage over prior art systems, ISP Software Package with DRM Media Management System was designed to address all four components of secured media distribution system. It fully integrates: media acquisition, digitalization, event provisioning and media assignment to the event, digital rights management and encryption process, media delivery to media servers and media storage so media can be delivered to the end-user according to business rules associated with the media delivery, license delivery and access to all three types of media delivery, live, on-demand and download.

For purposes of understanding and discussion, functionality of ISP Software Package can be divided in three feature groups: (1) Manager; (2) Encoder; and (3) Administrator. As noted, these categories are generated for purposes of understanding and as such, the claims that follow should not be interpreted as being limited to these enumerated groups.

Manager

The Manager provides integrated web access to Media Management System. Media may be delivered to the end-user according to business scenarios created, and scenarios are: (a) live; (b) on-demand; (c) download; or (d) subscription which can be live, on-demand, download or combination. Live, on-demand and download are considered one time events while subscription is created from recurring events, collection of recurring events, or event or collection of new events where end-user gets access to subscription media in exchange for recurring monthly, weekly or annual monetary fee.

The Manager may be designed as a Web browser embedded into ISP Software Package with browser capabilities that allow operator to navigate through the Media Management System. Operator can choose to use ISP Software Package to access Media Management System or a standard Internet browser such as Microsoft Internet Explorer browser. All information about the events including event title, event description, start time, end time, business scenarios, digital rights management encryption scheme elements including private key, public key, public certificate, license certificate, root certificate and content ID and event status may be stored in Media Management Database (MMD). Event status is a number value that indicates stage of digitalization and encryption process. For example, 0 indicates that event exists and it's ready to be digitalized and encrypted, 1 indicates that event media is in the process of digitalization and encryption, 2 indicates that digitalization and encryption has been completed and 3 indicates that created media has been uploaded to media storage for on-demand playback or downloading. In other embodiments other designators may be used.

In the example embodiment shown herein, the Manager and thus the Media Management System, is enabled with eight main features. These features of the Manager are: Administrators, Channels Manager, Package Manager, Event Media Manager, User Manager, Bulk Mail Manager, Affiliates Manager and Reports. Further explanation of the Event Manager's main features is now provided.

Administrators feature enables the operator to create access and user rights for other operators using the Manager. For example, an operator might want to add operators with full administrator rights but you also might want to add operator that has only rights to access media and packages but not other features. Access can be granted or denied to any of the eight features of the Manager.

The Channels Manager feature enables an operator to create and modify channels or ‘categories’ and assign packaged media to those channels. Channels may be dynamically displayed to the end-user and end-user can locate and navigate through channels to find packaged media with common subjects. For example, if looking for Rock music, you would click on Rock channel to locate all Rock music available using the ISP system.

The Package Manager feature enables an operator to package created events on a standalone basis or as a collection of events, set purchase price, assign a preview so end-users can preview the package before the purchase, provide package description, start and end date, rating, assign graphical display for the package (image or flash file), create distribution scenarios and assign desired media access rights by defining the media license rights and create subscriptions. By way of example, suppose an operator has three soccer games: game A, game B and game C. With s packaging system the operator can sell any of the games individually or the operator can combine them and sell them as certain combinations. For example, to sell all three games together a user may create a package, named Watch games A, B and C; provide a brief description of the games; assign rating to it; upload image showing some interesting moment from the game and upload a 60 second preview. Thereafter this package may be sold live and on-demand. An operator can create a live scenario, assign a price that would be charged to end-users to buy it, and put media access rules such as: license expiration on store, license expiration on first use, play count or number of times end-user can play the media, what happens if end-user rolls date back on their computer, number of times end-user can transfer media to a portable device, number of times media can be burnt to a CD, type of rights end-user has once media is transferred to portable device, security level, license expiration date for portable devices, license begin date, license expiration date and if user is allowed to back up license or not. These are all features that could be assigned to media to control access rights.

The Event Media Manager enables an operator to add and modify events, set titles, start and end dates and reset expired events. The User Manager enables an operator to manager all end-users on the system. Once any end-user buys content he or she may be registered in MMD and all information such as name, address, payment type, credit card number or bank account number, packages purchased is also stored in MMD so that an operator can manage their end-users in real time. An operator can view all users, go to a detail mode to determine what package is being bought by the end-user, if content of the package has been viewed or not, issue refund on a purchase, reset viewing, modify address or payment type or cancel subscription if end-user has subscribed to subscription package.

The Bulk Mail Manager enables an operator to create email campaigns that promote new, upcoming or existing packages/events and market them to opt-in end-users. When end-user purchases, packages, and creates an account using the ISP system the method and apparatus allows them to tell us if they want to receive emails and in what format and that information is used to determine if end-user should receive email or not.

The Affiliates Manager enables an operator to add affiliates, other websites that can link their websites to operator's portal and track number of end-users coming from the affiliate's site to and operator's portal and track their purchases. Using the Affiliates Manager the operator can assign a commission or percentage of a sale that an operator wants to credit to an affiliate for sending end-user to the portal to make a purchase.

The Reports section or manager enables an operator to view different reports such as total amount of revenue generated per month and when purchases were made, number of packages sold and total revenue generated per package, number of subscribers per month and number of all users per month.

In addition, Manager has a standalone feature built in that may be totally transparent and fully automated but plays an important role for subscription based mode. It is a recurring billing system that automatically checks MMD every day for subscribers that need to be re-billed for a next subscription period, re-bills them and sends a report to operator.

Encoder

A discussion is now provided with regard to the Encoder component or feature. The Encoder component provides lists of all events stored in MMD and ready to be digitalized, encrypted and distributed, preview of the video media being digitalized and encrypted, audio volume level indicator, encoding time (duration of media digitalization and encryption process expressed in hours: minutes: seconds format) and two buttons: (1) First button is Start Encoding button that invokes media digitalization and encryption process and turns into Stop Encoding button once pressed to stop the media digitalization and encryption process and if pressed a second time, it turns back to Start Encoding button. In one embodiment the Start Encoding button can not be pressed unless the operator has selected the event to be digitalized and encrypted and the Stop Encoding button does not appear unless digitalization and encryption process is active; (2) Refresh List button enables operator to make request back to MMD to check if any of the new events have been added and await digitalization and encryption process. Once ISP Software Package is started it may automatically check with MMD if there are any events waiting to be digitalized. All data retrievals and data posts to the MMD may be conducted via HTTPS call to Media Management System using XML socket and dynamic web pages. HTTPS may be set to use 128 bit Secure Socket Layer (SSL) connection. An encrypted SSL connection requires all information sent between a client and a server to be encrypted by the sending software and decrypted by the receiving software, thus providing a high degree of confidentiality. Confidentiality is important for both parties to any private transaction. In addition, all data sent over an encrypted SSL connection may be protected with a mechanism for detecting tampering—that is, for automatically determining whether the data has been altered in transit.

In addition, all calls may be authenticated against the MMD to prevent unauthorized access using identification ID further described below. Further, a timer may be built into ISP Software Package that automatically checks with MMD for new events or changes to the existing events and updates the event list. In one embodiment the Encoder uses Microsoft Windows Media Encoder Software Developer Kit (SDK) to access features of Microsoft Windows Media Encoder. In one embodiment all ISP Software Package functions may be executed with a mouse click or with a touch if ISP Software Package is installed on a computer with a touch-screen monitor. In one embodiment a complete media digitalization and encryption process may be completed with three clicks. The three clicks, i.e. three major steps of operation are now described.

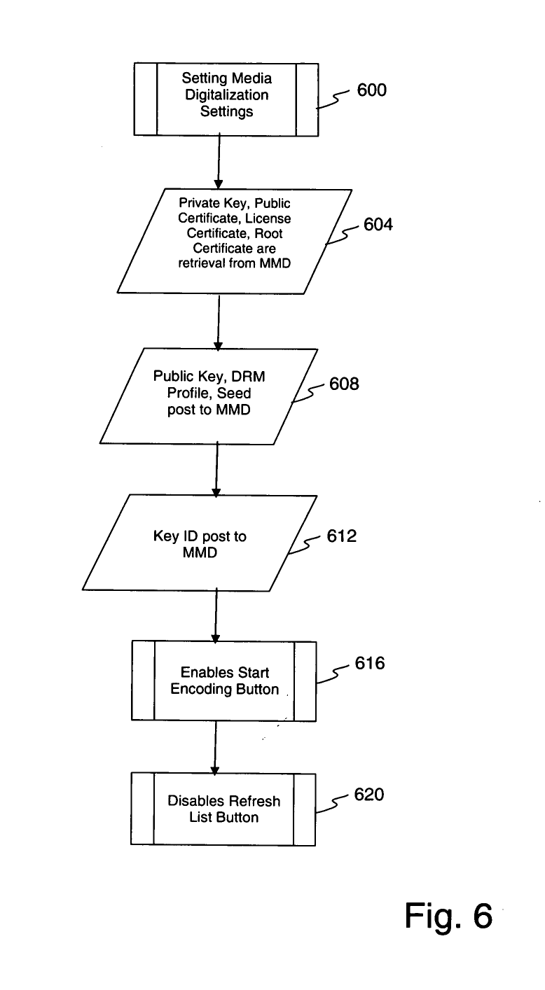

FIG. 6 illustrates an operational flow diagram of an example method of a first click initialization process. During a first click operation the Operator clicks on an event in the event list. This click invokes the following processes. At a step 600, the operator may set audio and video capture device, sets video source, sets audio source, sets broadcast or encoding type, sets live broadcast settings, and sets Windows Media Encoder to ready mode. During a step 604, the ISP Software Package may retrieve private key, public certificate, license certificate and root certificate from the MMD using Media Management System. At a step 608, the first click operation of the ISP system may post Public key, DRM Profile and seed to the MMD via HTTPS call to Media Management System using XML socket and dynamic web page.

Thereafter, at a step 612, the ISP Software Package generates the Key ID and posts it to the MMD via HTTPS call to Media Management System using XML socket and dynamic web page. And at step 616 the operation enables the Start Encoding button and at a step 620 disables the Refresh List button. This is but one example method of operation and as such, the claims that follow are not limited to this particular embodiment.

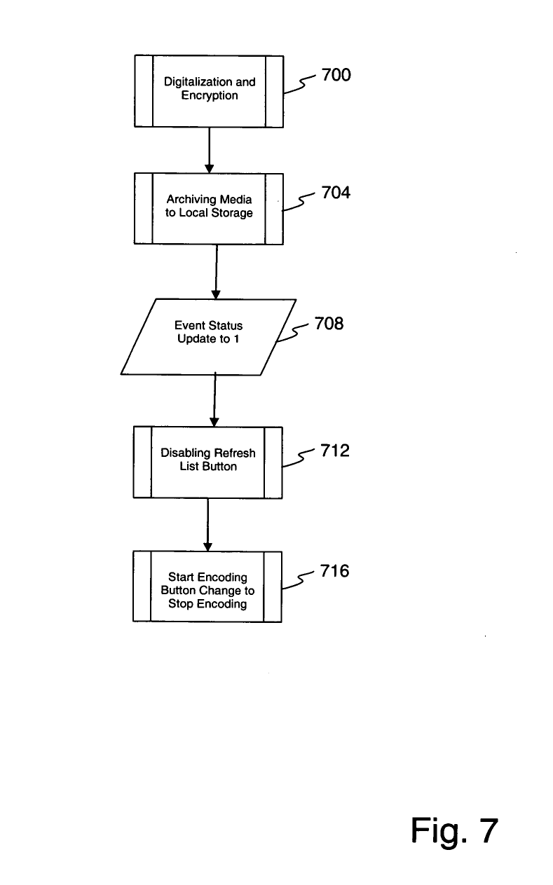

FIG. 7 illustrates an operational flow diagram of an example method of a second click encoding process. As part of the second click operation, an operator clicks on Start Encoding button. This invokes the following processes. At a step 700, the digitalization and encryption process is started. Then, at a step 704, the operation archives the created media. At a step 708, the Event Status is updated to status 1 in the MMD via HTTPS call to Media Management System using XML socket and dynamic web page. At a step 712, the disallowed application shutdown disables the Refresh List button. At step 716, the second click operation changes the Start Encoding button to Stop Encoding Button. This is but one example method of operation and as such, the claims that follow are not limited to this particular embodiment.

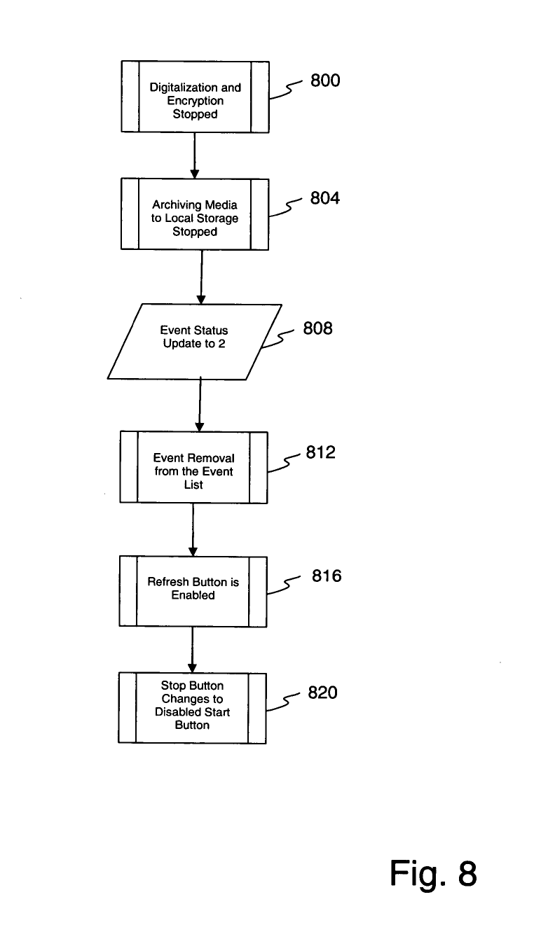

FIG. 8 illustrates an operational flow diagram of an example method of a third click stop encoding operation. The third click or (Click 3) operation may be initiated by an operator clicking on Stop Encoding button. This invokes the following processes. At a step 800, the digitalization and encryption process is stopped. At a step 804, the archiving media is stopped and then, at a step 808, the event status is updated to status 2 in the MMD via HTTPS call to Media Management System using XML socket and a dynamic web page. At a step 812, the event is removed from the list and, at a step 816, the system enables Refresh List button. Likewise, at a step 820, the system changes the Stop Encoding button to disable the Start Encoding button. Of course, this is but one example method of operation and as such, the claims that follow are not limited to this particular embodiment.

The process of uploading created media files for on-demand playback or downloading may also be fully automated. ISP Software Package has a built in timer that connects to MMD via HTTPS call to Media Management System using XML socket and dynamic web page and checks if there are any events with Event Status 2. If there are events with Event Status 2 and the ISP Software Package may be set to create on-demand and download media inside the Administration section, the ISP Software Package analyzes the created media by determining the media duration, creates FTP or SFTP session with the media storage and uploads the media file. Once a media file has been uploaded, the ISP Software Package may connect to the MMD via HTTPS call to Media Management System using XML socket and dynamic web page and updates the Event Status to status 3, writes event duration and URL paths to the media for on-demand streaming and downloading.

Further explanation of the Event Status and one embodiment of how it may be configured to provide a managed access to live, on-demand and download media is now provided. In one example method of operation, referred to herein as Case 1 an end-user is granted or has access or authorization to a live event but, if Event Status equals to 0, the end-user can not get access to the media URL path because: (a) a live event has not started yet; or (b) a proper license can not be issued because Key ID has not been passed back to the MMD. In this case, the end-user is notified that the live event has not started yet. Once Event Status is changed to 1, the end-user may be granted access to media URL path because live event is in progress and License Service Provider can issue a proper license because Key ID has been posted into MMD. Once Event Status is changed to 2, the end-user can not get access to media URL path because the live event has ended. In this case, the end-user may be notified that the live event has ended.

In an example situation referred to herein as Case 2, an end-user has access to live and on-demand event, then Case 1 stands, and in addition, once Event Status changes to status 3, meaning the media has been uploaded and URL path to media has been set, then the end-user is allowed access to media path for on-demand playback.

In an example situation referred to herein as Case 3, an end-user has access to on-demand event or media download. As a result, the end-user only gets access to media URL for on-demand playback or for the download once the Event Status is set to status 3, meaning the media has been uploaded to the storage and URL path to on-demand and download playback has been set.

Administrator

The ISP method and apparatus as described herein also comprises an administration section that enables an operator to modify multiple settings and functional elements of the ISP Software Package. It may be designed to give an operator full flexibility to choose how: (a) ISP Software Package acquire video and audio signal; (b) what type of media delivery will be performed; (c) what file storage will be used; (d) what file uploading method will be used; (e) media archiving path on local machine; and (f) what encoding profile will be used. For example, video and audio can be acquired from any video and audio capturing device installed, including digital and analog signal processing devices. An operator can choose to deliver media live, on-demand, download or combination. In addition, an operator can choose any type of file storage capable of delivering media files by inputting base URL path to the storage for on-demand and download playback. ISP Software Package automatically adds media file name at the end of base URL and updates the MMD so URL paths to the media can be dynamically provided to the end-users. For example, an operator can choose file transfer protocol (FTP) or secure file transfer protocol (SFTP) by inputting FTP/SFTP settings such as URL path and username and password. The operator can choose where created media will be stored on the local machine and the operator can choose encoding profile among custom built collection of encoding profiles.

In addition, it is contemplated that all above listed updates/modifications are done without having to restart the ISP Software Package. Further it is contemplated that the features listed herein are provided by way of example and not limitation.

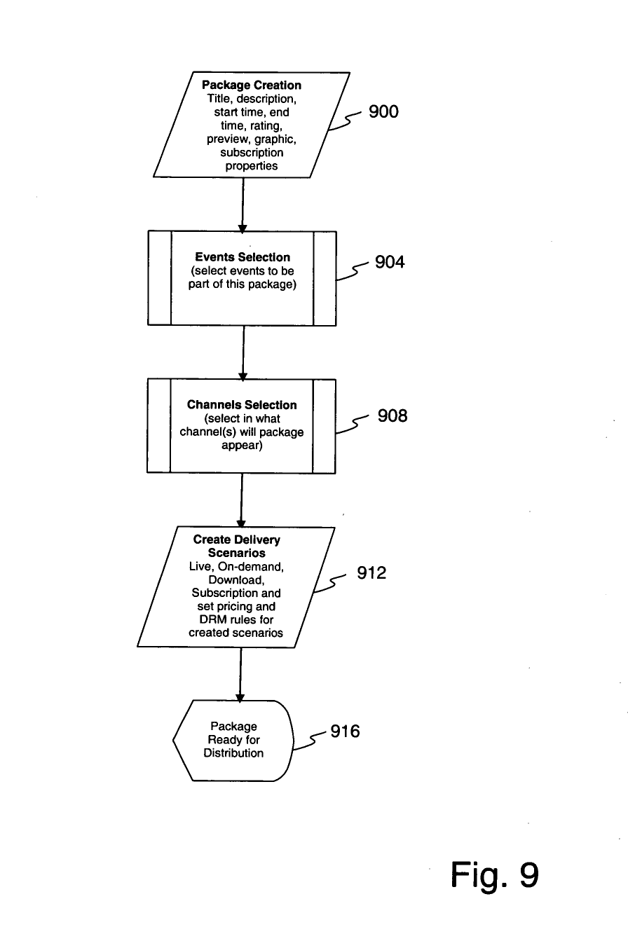

FIG. 9 illustrates an operational flow diagram of an example method of package creation. This is but one possible method of package creation and as such, the method and apparatus described herein should not be considered as being limited to this method of package creation. At a step 900, the package creation operation, such as may be performed by an operator, establishes a package title, description, start time, end time, rating, preview, graphic, subscription properties or any other attribute as may be contemplated by one of ordinary skill in the art. At a step 904, the method performs the event selection operation whereby the operator may select events to be part of the package. This may occur in any manner. At a step 908, the operator may select the channels. This may comprise selecting in which channels package will appear. Then at 912, the operator creates delivery scenarios. In one embodiment this comprises live delivery, on-demand delivery, download, subscription and pricing establishment, and establishing the DRM rules. Other actions may be taken in establishing the package. At a step 916, the package is ready for distribution.

As an advantage over prior art systems, ISP Software Package can be used by a virtually indefinite number of operators having access to, creating and delivering same or different media. During the installation process of ISP Software Package, an operator may be asked to provide a unique identification ID. This identification ID gets installed in the registry of the local computer hosting ISP Software Package and determines what events will be displayed in the Encoder Event List. Meaning, only events that belong to an operator identified by the identification ID will be displayed. The Identification ID may be authenticated against the MMD every time ISP Software Package makes updates or retrieves the data from MMD via an HTTPS call to Media Management System. The operator can use the Event Manager to add new events, modify existing events but can not display any other events other than those events authenticated by the identification ID unless, in one embodiment, the ISP Software Package is uninstalled and a new identification ID may be assigned.

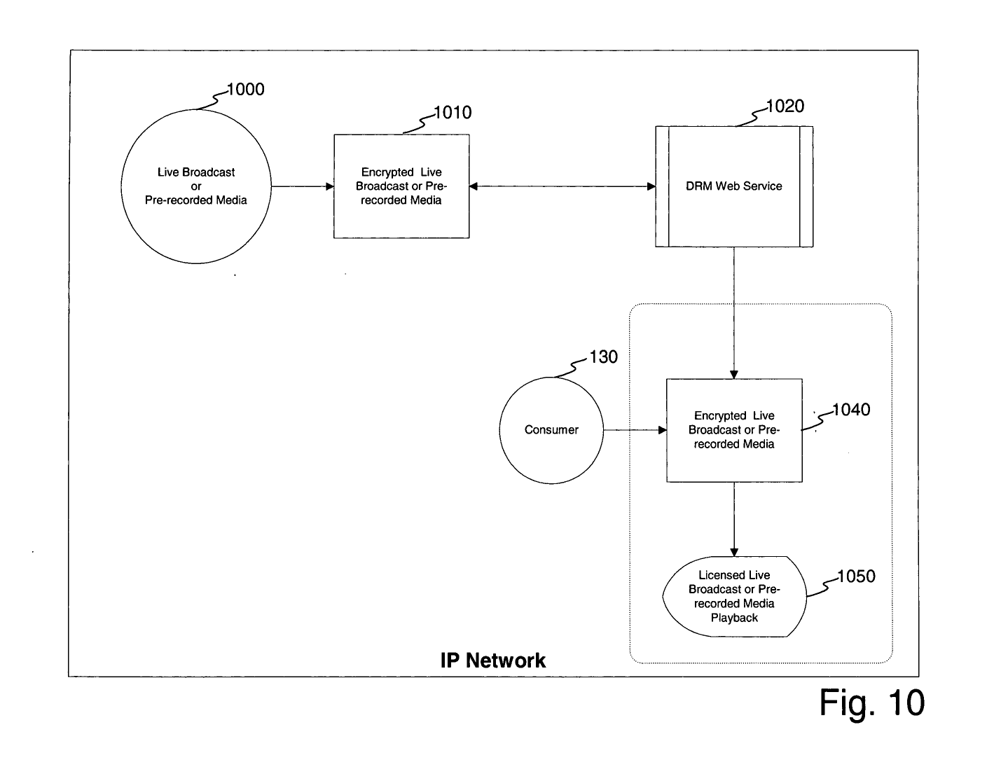

FIG. 10 illustrates a block diagram of an example environment of use and exemplary system utilized or accessed during use of an embodiment of a method for clearing and delivering licenses to device on IP networks. Without limiting this disclosure, it is contemplated that the ISP system and method described herein may operate in other exemplary environments.

As shown in FIG. 10 of this example embodiment of a method for clearing and delivering licenses, according to a feature of the method, one or more live broadcast or pre-recorded media 1000 may comprise any type event such as any concert or competition or performance, or may comprise one or more prerecorded events, such as previously digitized performances. Initially, one or more encrypted live broadcast or pre-recorded media 1010 may be created by encrypting live broadcast or pre-recorded media with media digitization and encryption software. The encryption process creates a version of a media file or a broadcast that has been encrypted and locked with a “key” (see FIG. 2 and description above). All encryption information including an encryption key is stored at a DRM web service platform 1020. Before a consumer 1030 can play an encrypted live broadcast or pre-recorded media 1040 that is stored on content owner's Web site or media platform, the consumer needs to acquire a license to unlock the live broadcast or pre-recorded media.

In one embodiment the consumer may use a personal computer connected to the Internet as is understood by one of ordinary skill in the art. Moreover, those skilled in the art will appreciate that the invention may be practiced with other devices, including mobile phones, portable media players, set-top-boxes, digital video recorders, microprocessor-based or programmable consumer electronics, network PCs and the like, and combinations thereof.

In another step of the method, a request may be sent to DRM Web service 1020 to generate, clear and deliver one or more licenses with one or more pre-defined rights or rules that govern the use of a live broadcast or pre-recorded media 1000. DRM Web service 1020 clears and delivers the license to the consumer 1030 who is now able to play one or more licensed live broadcast or pre-recorded media 1050 according to pre-defined rights or rules that govern the use of that particular live broadcast or pre-recorded media 1000.

Although the embodiment of the method is illustrated herein with only a single consumer and content provider, those of ordinary skill in the art will recognize that the invention can be practiced on a larger scale with multiple consumers and content providers.

It should be noted that this is but one possible implementation an example environment of use for the method described herein and as such the claims that follow should not be considered as being limited to the environment shown in FIG. 10.

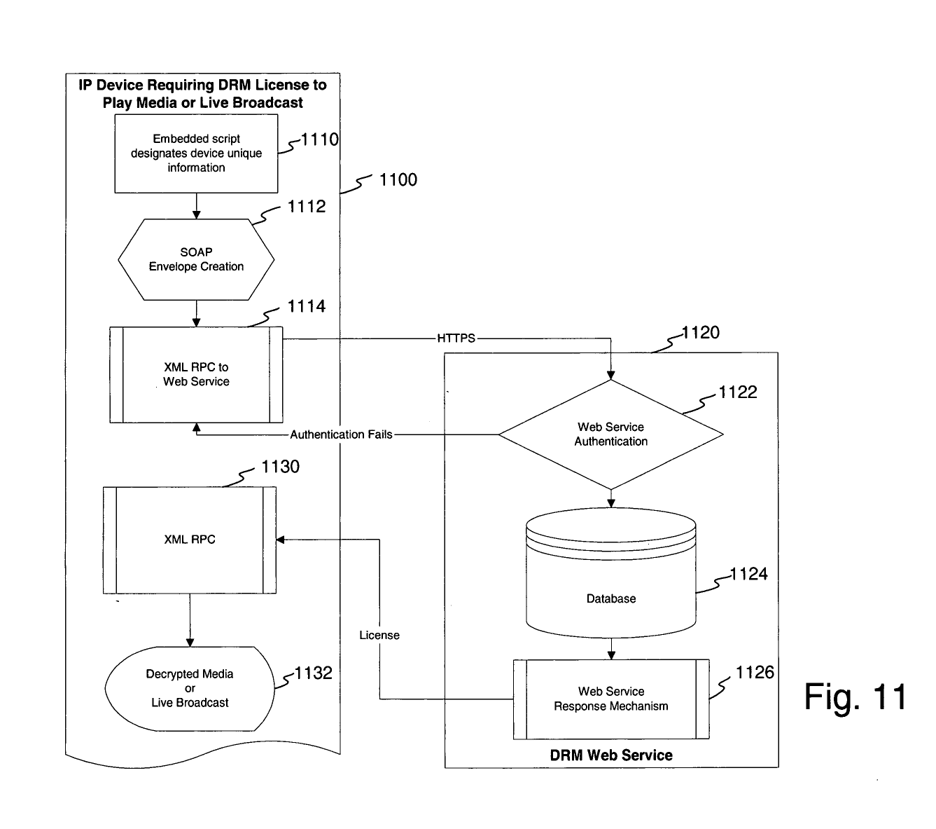

FIG. 11 illustrates a block diagram of an example embodiment of how a DRM Web service is used to clear and deliver a license so that a device on an IP network may play media or live broadcasts. Initially as shown in FIG. 11, an IP connected device 1100 may need a license to play one or more media and/or live broadcast. In one embodiment the IP device 1100 may be a personal computer requesting a license to play a live broadcast of an event from a remote web server. It will be appreciated that IP device 1100 may be any device configured to communicate with a Web service. Examples of an IP device 1100 may be any of: mobile phones, portable media players, set-top-boxes, digital video recorders, MPEP players, microprocessor-based or programmable consumer electronics, network PCs and the like, and combinations thereof.

The following is a description of features of IP device 1100. A script 1110 collects device unique information from IP device 1100 and generates an internal request to acquire one or more licenses for a portion of one or more media and/or live broadcast.

An XML-compliant, SOAP envelope 1112 of information is prepared, comprising such information as authentication (username and password), a license identifier, and a proposed expiration date of a license. The proposed expiration date is an override feature used to supersede a pre-existing license expiration date having predefined rights or rules that governed the use of the digital media or live broadcast previously. If the proposed expiration date is left blank, the expiration date of the pre-existing license from the pre-defined rights or rules will be used.

An XML remote procedure call 1114 (denoted XML RPC hereinafter) is placed to a DRM Web service 1120 by sending a SOAP envelope 1112 via SSL-secured protocol (such as HTTPS and the like). The RPC 1114 is placed into a “wait state” while waiting for a response from the DRM Web service 1120.

The DRM Web service 1120 receives the request, runs a Web service authentication 1122 process to verify that the request is valid. A validity check is performed against a database 1124 located at a DRM Web service to verify that information sent by the request, such as username and password, matches an encrypted username and password held in database 1124 and license identifier corresponds to DRM information also held in database 1124.

If the request is valid, database 1124 sends license key information that also includes rights or rules governing the use of digital media file or live broadcast, to a Web service response mechanism 1126.

Web service response mechanism 1126 wraps response information including a license key and sends it back to the XML RPC 1130 which is still in a “wait state.”

On receiving a response, a remote web server or IP device parses the response, ending the XML RPC 1130 “wait state,” and matches the response to encrypted media file or live broadcast. The resulting product is decrypted media or live broadcast 1132 that now permits successful playing of the decrypted media or live broadcast on IP Device 1100. Moreover, based on the parsed response, in another embodiment, the process can elect to either deliver a license key or take some other action. For example, if a key's information does not match, or a media file is unable to be unlocked, or an IP device media playback capability has been revoked, the script can elect to force a redirect to a different location or re-authentication.

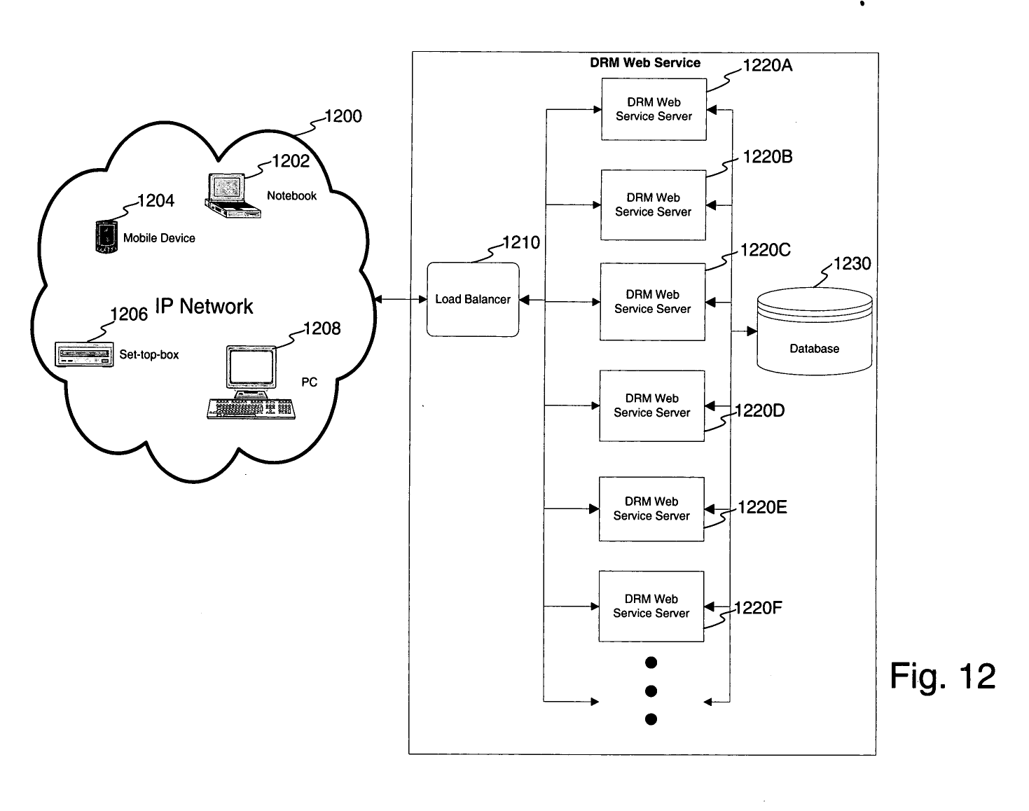

FIG. 12 illustrates a block diagram of an example embodiment of a DRM Web service infrastructure designed so the DRM Web service can be easily scaled up and load-balanced to accommodate virtually any number of license requests by various devices on IP network. This is but one possible infrastructure and as such one of ordinary skill in the art may arrive at other infrastructure configurations and methods of operation which do not depart from the claims that follow. It is contemplated that an IP network 1200 connects various devices such as notebooks 1202, mobile devices 1204, set-top-boxes 1206, and personal computers 1208 and the like, and combinations thereof. In this example embodiment a DRM Web service server farm comprising one or more DRM Web servers 1220A, 1220B, 1220C, 1220D, 1220E, 1220F, is load balanced using load balancer 1210. Load balancer 1210 distributes license requests across all servers hosting Web service and who are connected to one or more databases 1230 that hold all license information.

The term “load balancing” refers to distributing processing and communications activity evenly across a network so that no single device is overwhelmed. This may happen where the number of requests made to a server and the number of responses from the server is unpredictable. One solution for busy Web services is typically to use two or more Web servers to run Web services in a load balancing scheme. Requests are distributed equally across the bank of servers so no single server is overwhelmed and forced to deny requests because of lack of processing capacity. No further detail of load balancers is shown since these are generally understood by persons skilled in the art.

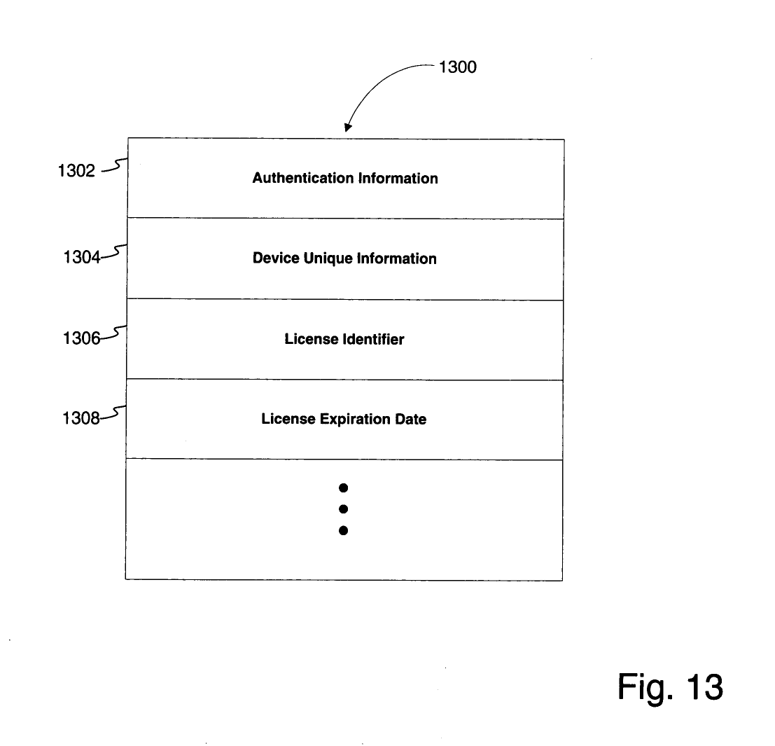

FIG. 13 illustrates a schematic of an example embodiment of a SOAP envelope structure for use in an exemplary implementation of the invention. This schematic illustrates several data fields of a SOAP envelope which may be located in a memory of a device. One of ordinary skill in the art may arrive at other embodiments without departing from the scope of the invention. In this example embodiment, SOAP envelope 1300 comprises authentication information 1302, device unique information 1304, license identifier 1306 and license expiration date 1308. In one embodiment the authentication information 1302 consists of content owner's assigned username and password and is used to verify user authenticity. Device unique information 1304 comprises information on a device's hardware configuration and other information required by DRM service. License identifier 1306 points to license key information and one or more rights or rules that govern the use of one or more digital media file or live broadcast. License expiration date 1308 is an override feature used to supersede a license expiration date already pre-defined in the rights or rules that govern the use of digital media or live broadcast (see FIG. 12 and description above). If license expiration date 1306 is left blank, the date from the pre-defined rights or rules may be used as the expiration date for digital media or live broadcast. Other information can be passed to a Web service to extend reporting or functional capabilities.

As an advantage over the prior art, the method described and claimed herein utilizes a Web service to unify numerous complex steps and insure proper interface between otherwise potentially incompatible software and hardware modules which can be distributed at various remote locations. License clearing and delivery may then be performed seamlessly and transparently to a virtually unlimited number of devices connected by IP networks. Absent the method described herein it would not be possible to synchronize, scale and load-balance operation of various activities to achieve seamless and transparent license clearing and delivery to virtually unlimited number of devices connected by IP networks.

While various embodiments of the invention have been described, it will be apparent to those of ordinary skill in the art that many more embodiments and implementations are possible that are within the scope of this invention.

What is claimed is:

1. A method for clearing and delivering a license to an IP connected device comprising the steps of:
generating an internal request by at least one IP connected device to acquire at least one license for at least one of the following: a portion of media and a live broadcast from at least one Web service hosted by at least one server;
preparing an XML-compliant SOAP envelope;
making at least one RPC to the at least one Web service by the at least one IP connected device;
passing the SOAP envelope to the at least one Web service via an SSL-secured protocol;
waiting for authentication of the at least one RPC against user information stored in a database of the at least one Web service; and
playing at least one of the following: a portion of media and a live broadcast by the IP connected device after receiving a license key along with at least one of rights and rules governing the use of at least one of a portion of media and live broadcast.

2. The method of claim 1 wherein the SOAP envelope further comprises at least one license identifier and device unique information corresponding to at least one IP connected device.

3. The method of claim 1 wherein the SOAP envelope further comprises authentication information.

4. The method of claim 1 further comprising the step of:
pointing the unique license identifier to license key information and to the at least one of rights and rules that govern the use of at least one of a portion of media and live broadcast.

5. The method of claim 4 further comprising the steps of:
storing the license key information and the at least one of rights and rules that govern the use of at least one of a portion of media and live broadcast in the database; and
accessing the license key information and the at least one of rights and rules by the Web service.

6. The method of claim 1 further comprising the step of:
overriding a pre-existing license expiration date defined in the at least one of rights and rules that govern the use of at least one of a portion of media file and live broadcast with a license expiration date specified by the SOAP envelope.

7. The method of claim 1 further comprising the steps of:
providing at least one load balancer of at least one Web service; and
scaling and load balancing the at least one Web service to simultaneously accommodate requests from IP connected devices.

8. The method of claim 1, further comprising the step of:
clearing and delivering at least one license for archived, pre-recorded media and live broadcasts.

9. The method of claim 1 wherein the at least one SSL-secured protocol comprises HTTPS.

10. The method of claim 1, wherein the at least one IP connected device comprises circuitry configured to communicate with the Web service and is selected from the group consisting of at least one of a computer, a mobile device, a microprocessor-based device and a set-top-box.

11. The method of claim 10, wherein the at least one computer is selected from the group consisting of a notebook, a laptop and a personal computer, the at least one mobile device is selected from the group consisting of a mobile phone and a portable media player, and the microprocessor-based device is selected from the group consisting of an MPEP player and a digital video recorder.

12. A method of clearing and issuing licenses by at least one DRM Web service to at least one IP device to play copyrighted media and live broadcast comprising the steps of:
collecting device unique information from at least one IP device;
receiving an XML RPC from at least one IP device comprising an XML-compliant SOAP envelope having device unique information and at least one license identifier to request at least one license for at least one of the following: a portion of digital media and live broadcast;
placing the XML RPC in a wait state;
comparing authentication information and at least one license identifier with at least one database located at the DRM Web service by running a Web service authentication;
verifying that the license identifier and authentication information matches a DRM information and encrypted username and password held in the at least one database;
sending license key information including at least one of rights and rules governing the use of at least one of the following: digital media file and live broadcast to a DRM Web service response mechanism;
wrapping response information comprising at least one license key information by the DRM Web service response mechanism;
sending the response information to the XML RPC;
parsing the response information to end the XML RPC wait state;
matching the response information to at least one of the following: encrypted media file and live broadcast; and
decrypting at least one of the following: encrypted media and live broadcast to permit playing of at least one of decrypted media and live broadcast on at least one IP device.

13. The method of claim 12 further comprising the steps of:
providing the SOAP envelope comprises at least one of authentication information and a proposed expiration date of at least one license; and
superseding an existing license expiration date of at least one IP device with the proposed expiration date unless the proposed expiration date is not included in the SOAP envelope.

14. The method of claim 12, further comprising the step of:
forcing a redirect to another location for re-authentication if at least one of the following: license key information does not match, media can not be decrypted or an IP device media playback capability has been revoked.

15. The method of claim 12, wherein the DRM Web service is hosted by at least one DRM Web service server.

16. The method of claim 12 further comprising the steps of:
providing at least one load balancer of the DRM Web service; and
scaling and load balancing the at least one DRM Web service to simultaneously accommodate multiple IP connected devices.

17. A system for providing a DRM license to play copyrighted media and live broadcast, comprising in combination:
at least one IP device having an embedded script designating device unique information, the IP device in secured communication with at least one DRM Web service hosted by at least one DRM Web service server configured to receive an XML-compliant SOAP envelope having DRM information and to transmit at least one license to decrypt at least one of a portion of media and live broadcast for playing on at least one IP device.

18. The system according to claim 17, wherein a portion of the system includes at least one load balancer configured to facilitate communication between at least one IP device and at least one DRM Web service.

19. The system according to claim 17, further comprising username and password information.

20. The system according to claim 17, wherein the SOAP envelope comprises a proposed expiration date of at least one license configured to supersede an existing license expiration date of at least one IP device with the proposed expiration date unless the proposed expiration date is not included in the SOAP envelope.
